(19) United States
(12) Patent Application Publication
(10) Pub. No.: US 2007/0172092 A1
(43) Pub. Date: Jul. 26, 2007

(54) Digital information improvements for spas

(75) Inventors: Jeremy Richard Mommerency, Monroe, MI (US); James Allen Buslepp, Plymouth, MI (US)

Correspondence Address: CARLSON, GASKEY & OLDS, P.C., 400 WEST MAPLE ROAD, SUITE 350, BIRMINGHAM, MI, 48009, US

(73) Assignee: Watkins Manufacturing Corporation

(21) Appl. No.: 11/327,936

(22) Filed: Jan. 9, 2006

(51) Int. Cl. H04R 1/02

(52) U.S. Cl. 381/386; 719/321

(57) ABSTRACT

A spa is provided with a controller that includes a digital music player. The digital music player may locally receive files such as through a USB port, or can remotely receive files such as from a home computer. Further, the controller communicates over the internet with a remote location such as a maintenance location. In this manner, chemical levels and notice of any failures within the spa can be communicated directly to the maintenance location without the need for any operator action to be taken. While the invention is specifically shown as a spa having a digital music player, other digital media players such as video players would come within the scope of this invention. Moreover, other bathing items such as steam showers, tubs with jets, etc. would also come within the scope of this invention.

### BACKGROUND OF THE INVENTION

This application relates to a spa or other bathing item, wherein the spa is provided with improved digital abilities such as the ability to communicate over the internet, or to play digital media files.

Spas are utilized to provide water jets to a user for relaxation. Often, a spa is provided with an electronic control that controls water temperature, running time, and other operational aspects. Moreover, high end spas are provided with built-in stereo systems. However, spas have not been provided with access to digital music or video files, and thus have limited the ability for a user to import desired media files for playing at the spa.

### SUMMARY OF THE INVENTION

In a disclosed embodiment of this invention, a spa is provided with an MP3 player, or some other digital media player. The player interfaces with the control on the spa. The control and digital media player communicate with a remote location, such as with a home computer. Digital media files can be passed over a connection line from the home computer to the digital media player. On the other hand, a local port such as a USB port can be provided at the digital media player such that music or video can be downloaded to the digital media player.

In another aspect of this invention, the spa controller communicates over the internet to a remote location such as a maintenance location. Aspects of the spa's maintenance such as the need for additional chemicals, or the identification of any operational problems can be transmitted to the maintenance location. The maintenance location can thus plan and be more proactive in maintaining the spa. While the invention is specifically disclosed as a digital music player incorporated into a spa, the invention does have applications beyond those specific uses. Any type of digital media player such as a video player can be utilized. Moreover, any bathing item such as a bath with water jets, a steam shower, or any other item would come within the scope of this invention. For purposes of this invention, the term “bathing item having a tub” would extend to a shower having a simple shower enclosure.

These and other features of the present invention can be best understood from the following specification and drawings, the following of which is a brief description.

### BRIEF DESCRIPTION OF THE DRAWINGS

FIG. 1 is a schematic view of a spa incorporating the present invention.

FIG. 2 is a hardware diagram of the present invention.

FIG. 3 is a functional flow chart of the present invention.

### DETAILED DESCRIPTION OF THE PREFERRED EMBODIMENT

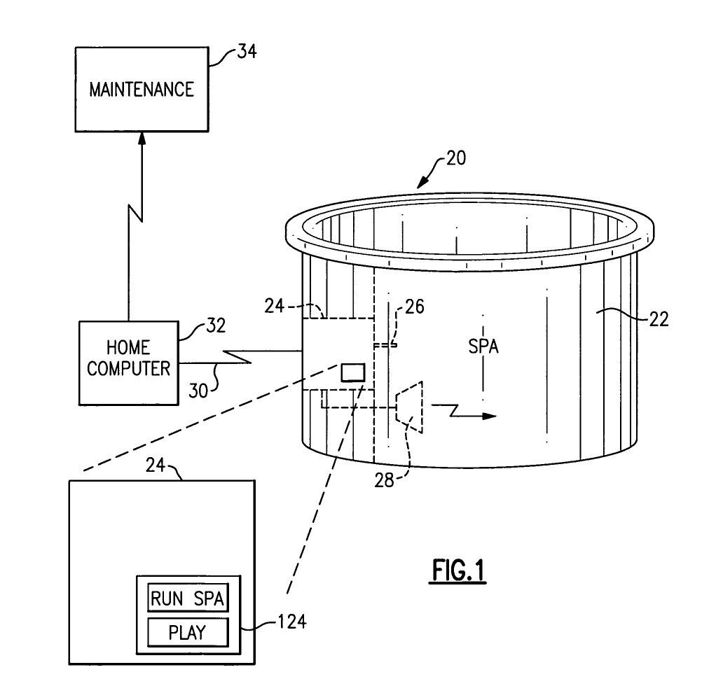

A spa 20 is illustrated in FIG. 1, having a tub 22, and a controller 24. The control operates as known to control the temperature of the water in the tub 22, the timing of water jet operation, etc. In the present invention, the controller 24 also incorporates a digital music player, such as an MP3 player. A USB port 26 is shown at the control 24 such that digital music files can be downloaded directly to the digital music player. A transducer 28 plays the music.

A connection 30 to a home computer 32 allows digital music or video files to be downloaded to the digital music player from a remote location such as a home computer 32. Alternatively, the connection to receive the digital media can be from some location on the internet, either through the home computer, or directly to the video music player. As one example, commercial sites are known, and may be utilized. Further, the controller 24 is able to communicate over the communication line and through the home computer 32 over the internet, to a remote location such as a maintenance location 34. When the controller 24 identifies a problem in operation of the spa 20, it can communicate directly to the maintenance location 34. Also, the need for periodic maintenance such as the addition or changing of chemicals at the spa 20 can be communicated to the maintenance location 34. The maintenance location 34 is thus able to send maintenance personnel to the location of the spa 20 as the need for the maintenance approaches.

The present invention thus improves upon the prior art by allowing the communication of digital music files to the spa 20. Further, the spa 20 is able to communicate over the internet for various maintenance functions. Communication can be directly to the internet, rather than through the intermediate home computer. Also, the communication can be wireless, rather than the hardwired illustrated embodiment.

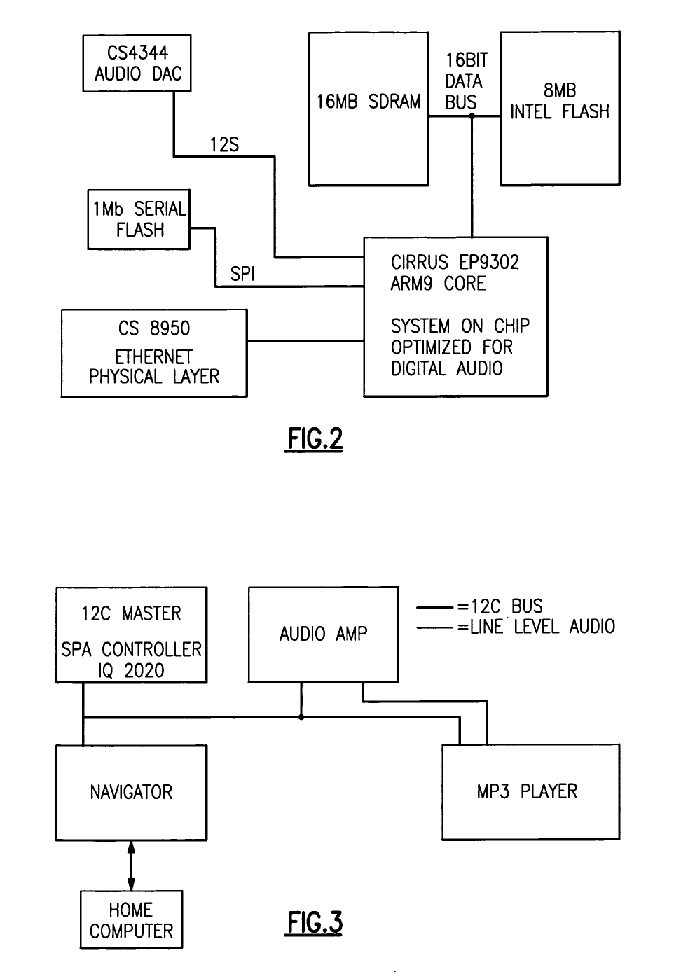

FIG. 2 is a hardware flow chart of the various aspects incorporated into the controller for the spa. It should be understood that this is but one example.

FIG. 3 is a functional diagram of the controller. Again, this is but one example.

The NAVIGATOR as shown in FIG. 3 is part of the controller 24, and includes an input device 124 through which the user may control operation of the spa, and also play, download, etc. digital files at the digital media player. The inputs “RUN SPA” and “PLAY” are shown as simplistic. In practice, and as known, much more detailed input options are provided. What is shown schematically is the fact that an input device incorporates the ability to control both the spa operation, and the digital media player.

The invention also has the ability to play digital audio files streamed from the home computer directly to the digital music player. The controller consists of a microprocessor and a ram. Preferably, some operating system such as Windows Ce or Linux may be utilized. The processor may be the same or similar to those running a pocket personal computer.

Again, while the invention is specifically disclosed in a spa, the invention would expand to any bathing item as described above. Moreover, any digital media player would come within the scope of this invention. That is, the invention does extend to digital video players.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A bathing item comprising:
a tub for receiving and distributing heated water; and
a controller and a digital media player associated with said bathing item, said digital media player being operable to receive digital files for playing.

2. The bathing item as set forth in claim 1, wherein said digital media player is provided with a local port to receive digital files.

3. The bathing item as set forth in claim 1, wherein said digital media player is operable to receive digital media files from a remote location.

4. The bathing item as set forth in claim 3, wherein a home computer communicates with said digital media player to transmit digital files.

5. The bathing item as set forth in claim 4, wherein said controller also communicates with a remote location over the internet.

6. The bathing item as set forth in claim 1, wherein said controller also communicates with a remote location over the internet.

7. The bathing item as set forth in claim 1, wherein said digital media player is a digital music player.

8. The bathing item as set forth in claim 1, wherein said bathing item is a spa.

9. The bathing item as set forth in claim 1, wherein said digital files come from a site on the internet.

10. The bathing item as set forth in claim 1, wherein an input device can control a digital media player, and operation of the bathing item for distributing water.

11. A method of operating a bathing item comprising the steps of:
(1) providing a tub for distributing heated water and a controller for controlling water distribution;
(2) providing a digital media player; and
(3) transmitting digital files to said digital media player to be played at said bathing item.

12. The method as set forth in claim 11, wherein said digital media player receives digital files over a local port.

13. The method as set forth in claim 11, wherein said digital media player receives digital files from a remote location.

14. The method as set forth in claim 13, wherein a home computer communicates with said digital media player to download digital files.

15. The method as set forth in claim 13, wherein said controller also communicates with a remote location over the internet.

16. The method as set forth in claim 11, wherein said controller also communicates with a remote location over the internet.

17. The method as set forth in claim 11, wherein said digital files are received from a site on the internet.

18. The method as set forth in claim 11, wherein an integrated user input device allows control of both the operation of the digital media player, and the bathing item's distribution of water.

19. A bathing item comprising:
a tub for heating and circulating water; and
a controller, said controller being operable to monitor operation of the bathing item, and said controller communicating over the internet with a remote location to provide indication to the remote location of the need for maintenance at the bathing item.

20. The bathing item as set forth in claim 19, wherein said controller communicates chemical additive information and information regarding any operational problem to the remote location.

21. The bathing item as set forth in claim 19, wherein said bathing item is a spa.

22. A method of operating a bathing item comprising the steps of:
(1) providing a tub for heating and circulating water;
(2) providing a controller; and
(3) monitoring operation of said bathing item at said controller, and communicating operational information from said controller to a remote location over the internet.

23. The method as set forth in claim 22, wherein said controller communicates chemical additive information and information regarding any operational problem to the remote location.

24. The method as set forth in claim 22, wherein the bathing item is a spa.
